(19) United States
(12) Patent Application Publication
(10) Pub. No.: US 2023/0409419 A1
(43) Pub. Date: Dec. 21, 2023

(54) TECHNIQUES FOR CONTROLLING LOG RATE USING POLICY

(71) Applicant: INTERNATIONAL BUSINESS MACHINES CORPORATION, ARMONK, NY (US)

(72) Inventors: AJAY GUPTA, Bengaluru (IN); ERAN RAICHSTEIN, Yokneam llit (IL); PRATIBHA MOOGI, Bangalore (IN); Pranjal Gupta, Bhilai (IN); Alan Conway, Raleigh, NC (US)

(21) Appl. No.: 17/806,953

(22) Filed: Jun. 15, 2022

(51) Int. Cl. G06F 11/07; G06N 5/02

(52) U.S. Cl. CPC G06F 11/0787; G06N 5/025; G06F 11/0721; G06F 11/0781

(57) ABSTRACT

A method, computer system, and a computer program product for automatic processing of computer logging events may be provided. In one embodiment, the process comprises determining an application priority model relating to a plurality of computer applications being executed on a device. A usage pattern model is also determined by monitoring utilization of the plurality of applications based on usage of the applications by a priority of users. A log flow control policy is also determined using logging information. All determined models also use a set of metrics to derive a log flow rules. These rules are used to manage log flow control policies when processing a plurality of logs.

### BACKGROUND

The present invention relates generally to the field of problem diagnosis and event log management in a computer environment, and more particularly to techniques for controlling log processing given different log rates in a cloud-based environment.

Event logs may be used to understand events that happen during the execution of a system operation. Event logs create an audit trail that will help diagnose problems. They may also help anticipate future issues that may lead to problems and manage better system operations. When problems arise, event logs may allow the attention to be focused on the right issues so that the problem can be resolved quickly. Event logs, therefore, may be an important resource and a main focus of every system operation.

Recording event logs for troubleshooting and monitoring system behavior may not without its challenges. When the systems are local and the number of server or operating system components are less numerous, event logs management may be relatively easy. However, in more complex environments, recording event logs and processing them to resolve arising issues in a timely manner may be challenging. The more complex the environment, the more difficult it may be to manage event logs. In distributed environments, such as cloud computing environments, managing event logs may be difficult. This is mainly because in such environments, while the applications and resources are typically deployed in a distributed manner, event log recording and processing may be collected and handled using local collectors.

Applications logs may be logged at various rates at different time periods based on application workload state, internal logic complexity, and logging practices. Unfortunately, these varied rates, especially in cloud computing environments may contribute to bottle necks that slow computing processing rates. Current prior art systems may not provide a good solution to resolve this problem effectively.

Consequently, a new technique may be desirous that can enable log processing that is being generated at different rates in a manner that does not create processing bottlenecks.

### SUMMARY

Embodiments of the present invention disclose a method, computer system, and a computer program for automatically processing computer logging events. In one embodiment, the process comprises determining an application priority model relating to a plurality of computer applications being executed on a device. A usage pattern model is also determined by monitoring utilization of the plurality of applications based on usage of the applications by a priority of users. A log flow control policy is also determined using logging information. All determined models also use a set of metrics to derive a log flow rules. These rules are used to manage log flow control policies when processing a plurality of logs.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 provides a flowchart illustration of a method according to one embodiment;

FIG. 3 provides an illustration of a logging bottleneck scenario;

FIG. 4 provides a block diagram showing an architecture for a log flow control policy according to at least one embodiment;

FIG. 5 illustrates a block diagram for an application usage pattern model development according to one embodiment;

FIG. 6 provides a block diagram illustrating an application log priority discovery according to one embodiment;

FIG. 7 provides a block diagram for a log flow control policy according to one embodiment;

FIG. 8 provides a block diagram illustrating the overall logging management process using different models according to one embodiment;

FIG. 9 provides a block diagram of internal and external components of computers and servers depicted in FIG. 1 according to at least one embodiment;

FIG. 10 provides a block diagram of an illustrative cloud computing environment including the computer system depicted in FIG. 1, in accordance with an embodiment of the present disclosure; and

FIG. 11 provides a block diagram of functional layers of the illustrative cloud computing environment of FIG. 10, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but may not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, may not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to customize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

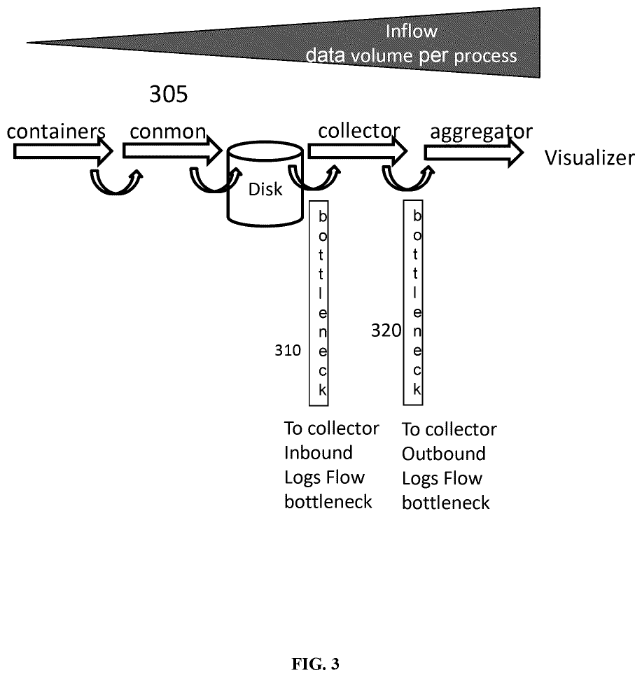

As discussed, logs are an important source for observability and provide information for troubleshooting and monitoring system behavior. In cloud computing environment, applications are typically deployed in a distributed manner while logs are collected using local collectors. Application logs get recorded at various rates and time periods based on application workloads state, internal logic complexity, and logging practices. There are situations in which less priority applications emit logs at a higher rate than higher priority applications. This often creates bottlenecks that affect system performance. A more detailed look at this problem has been provided in connection with FIG. 3 and will be discussed in more detail.

Consequently, it may be desirous to provide a system that can prevent such bottlenecks and improve system performance and integrity. Furthermore, it may be advantageous to, among other things, provide a technique to automatically manage and dynamically control logging rates based on current and historical operational data to minimize application-level critical log loss.

The following described exemplary embodiments provide a system, method and program product for automatically processing computer logging events. In one embodiment, the process comprises determining an application priority model relating to a plurality of computer applications being executed on a device. A usage pattern model is also determined by monitoring utilization of the plurality of applications based on usage of the applications by a priority of users. A log flow control policy is also determined using logging information. All determined models also use a set of metrics to derive a log flow rules. These rules are used to manage log flow control policies when processing a plurality of logs.

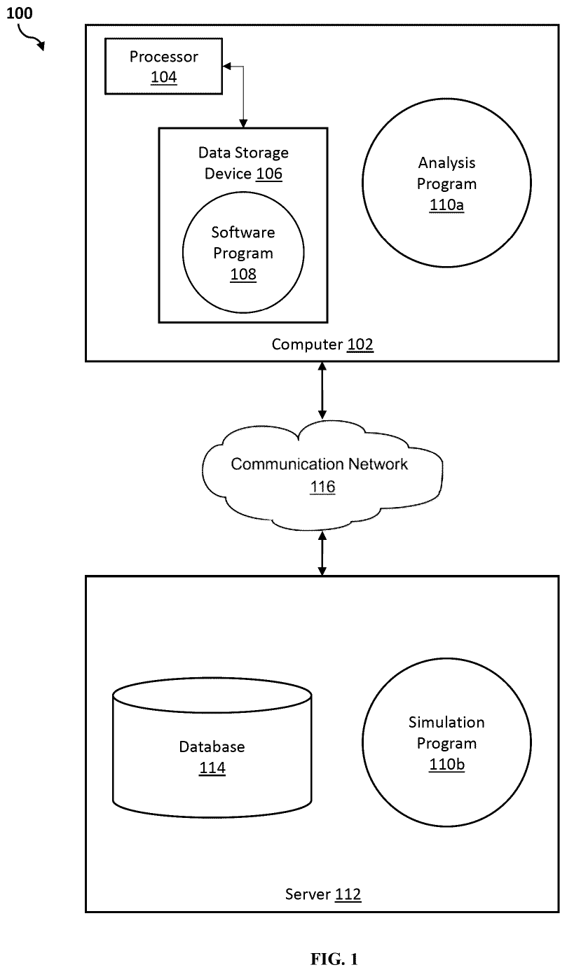

FIG. 1 provides an exemplary networked computer environment 100 in accordance with one embodiment. The networked computer environment 100 may include a computer 102 with a processor 104 and a data storage device 106, enabled to run a software program 108 and a log management program 110a. The networked computer environment 100 may also include a server 112, enabled to run a logging flow control application 110b that may interact with a database 114 and a communication network 116. The networked computer environment 100 may include a plurality of computers 102 and servers 112, only one of which has been shown. The communication network 116 may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

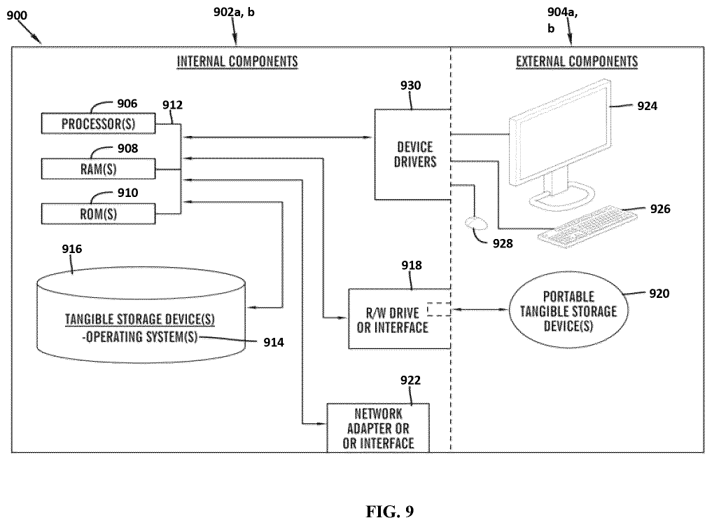

The client computer 102 may communicate with the server computer 112 via the communications network 116. The communications network 116 may include connections, such as wire, wireless communication links, or fiber optic cables. As will be discussed with reference to FIG. 9, server computer 112 may include internal components 902a and external components 904a, respectively, and client computer 102 may include internal components 902b and external components 904b, respectively. Server computer 112 may also operate in a cloud computing service model, such as Software as a Service (SaaS), Platform as a Service (PaaS), or Infrastructure as a Service (IaaS). Server 112 may also be located in a cloud computing deployment model, such as an exclusive cloud, community cloud, public cloud, or hybrid cloud. Client computer 102 may be, for example, a mobile device, a telephone, a customized digital assistant, a netbook, a laptop computer, a tablet computer, a desktop computer, or any type of computing devices capable of running a program, accessing a network, and accessing a database 114. According to various implementations of the present embodiment, log management program 110a, and logging flow control application 110b may interact with a database 114 that may be embedded in various storage devices, such as, but not limited to a computer/mobile device 102, a networked server 112, or a cloud storage service.

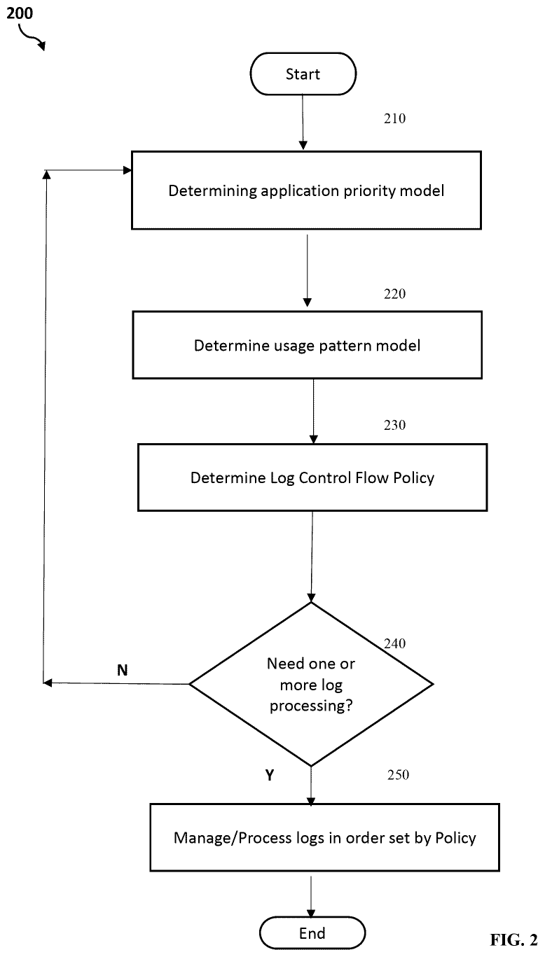

According to the present embodiment, a user using a client computer 102 or a server computer 112 may use the program 110a, application 110b (respectively) to provide a task management technique. This technique will be provided in more detail below with respect to FIGS. 2 through 8.

FIG. 2 provides a flowchart illustration of one embodiment for techniques to control and manage logging rates. The mechanism as will be further disclosed provides for techniques to automatically manage and dynamically control logging rates based on current and historical operational data to minimize application-level critical log loss.

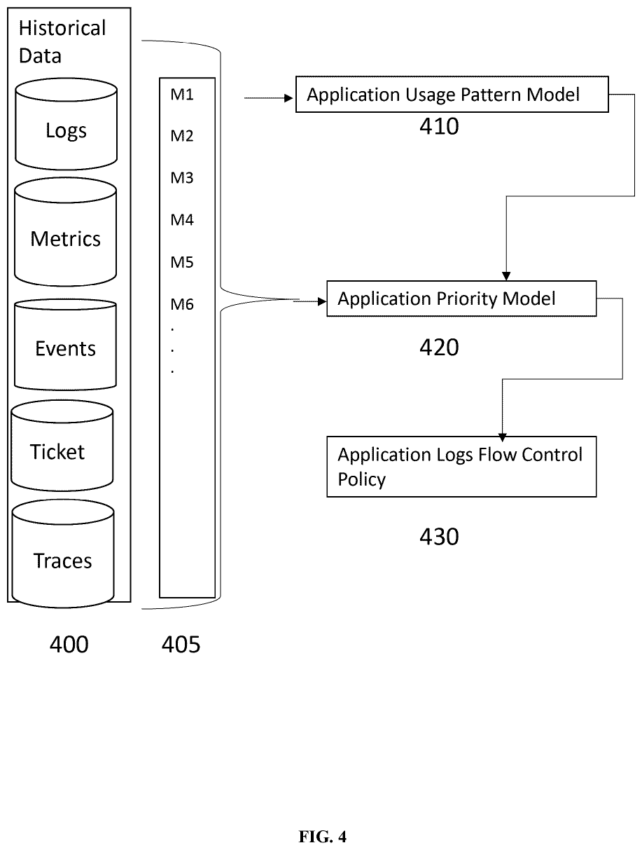

The process is generally enumerated as 200 and comprised of several steps. In step 210, application priority is determined for a plurality of applications running on at least one computer device. An application priority model is then determined. The applications that are being analyzed may be running on a plurality of computers, instead of just one device. These computers may be connected to one another via a network (LAN, WAN etc.) or through a cloud computing environment. The application priority may be automatically calculated and discovered through a variety of different components. These components can include historical or current metrics received. The metrics are continuously updated. These metrics include a variety of information such as logs (recordings etc.), traces, tickets and the resource usage information such as network or cluster usage. The application priority model provides a set of rules that will later be used for log control, management and processing. A more detailed look at these components are provided and further discussed in detail in connection with FIGS. 4-8.

In step 220, user patterns are analyzed and a usage pattern model is determined. Usage patterns are often based on the manner that a plurality of users may be utilizing the applications. A set of rules will also be provided by this model to be used in management of log flows later.

To provide ease of understanding, one example can be provided. In one embodiment, Application Workloads characterization are established based on several metrics. One of these metrics may be number of requests made by a user as a function of time. For example, usage may be monitored to see how many requests are made per hour of each day, and whether these are continued consistently or further dependent upon the “Day of Week”, “Week of Month”, “Month of Year” or other similar distributions.

Usage pattern model also uses a variety of metrics as before such as logs (recordings etc.), traces, tickets and the resource usage information such as network or cluster usage. Another metric used, may be the number of dependent services upon a particular application. Other important metrics may be the amount of usage of a particular component such as memory usage, or CPU (central processing unit) usage, or network usage. As before this information may be historical and/or current and will be continuously updated. A series of rules will also be developed to later help with log processing.

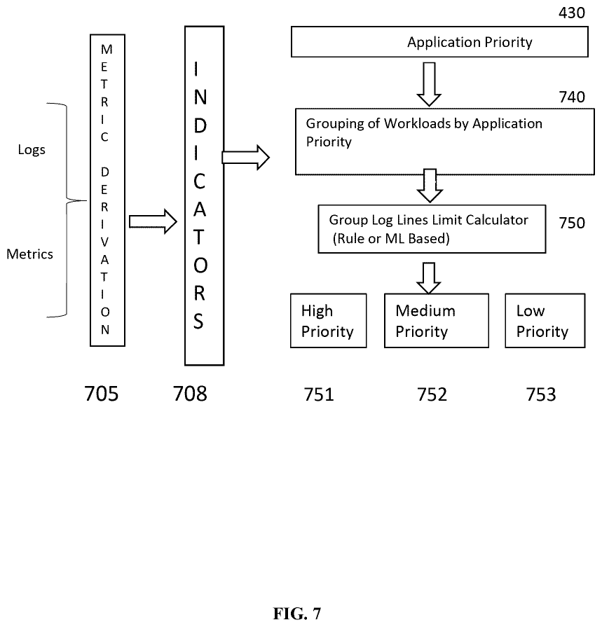

In Step 230, a log control policy may be determined. This policy takes the previous metrics (traces, tickets and the resource usage information) into consideration as well as additional information about log recordings including log severities etc. More details about this process is provided in relation with FIG. 7. The information provided here helps predict future logging behavior. Group log lines limits and a set of rules for processing logs are established in association with such prediction. The operation execution processing priority for log processing may be then established and executed based on the policy, once one or more logs are received for processing. The policy may be to determine which order the logs should be processed so that a bottle neck will not be caused.

In Step 240, it may be determined if one or more logs are received for processing. If there are no logs provided for processing, continuous monitoring will be conducted, and the steps 210-230 will be repeated as to update any newly received information. However, if one or more logs needs to be processed, as illustrated, the process moves to Step 250.

In Step 250, the number of logs that need to be processed may be determined. Other data may be also analyzed such as rate, number of logs that required simultaneous processor and other similar information as can be appreciated by one skilled in the art. Once this information is obtained, then the flow policy previously provided and the rules developed by steps 210-230 (models) are used to manage and process logs (such as according to the rules/policy). This will allow logs to be automatically managed and dynamically controlled (independent of their rates) based on current and historical operational data to minimize application-level critical log loss.

FIG. 3, as discussed earlier provides an example that reflects on the manner bottlenecks are created in processing logs. In this example, a scenario has been provided that utilizes a cloud computing environment. In cloud computing environments, applications are typically deployed in a distributed manner while logs are collected using local collectors. Applications logs get logged at various rates at different time periods based on application workloads state, internal logic complexity, and logging practices. There are situations in which less priority applications emit logs with higher rate than higher priority applications. Typically, collectors have a fixed capacity (logs bytes per second) to collect and process logs given an allowed CPU resources utilization limit so there are occurring situations where high priority application logs get dropped at the cost of collecting low priority logs. This creates bottle necks during collector and aggregator phases as shown in FIG. 3 at 310 and 320. The intent of FIG. 2 is to examine all data so that the set of rules provided will not cause this situation. The historical data of such a bottle neck, if recorded, will be provided as part of the set of historical metrics discussed.

FIG. 4 illustrates how different metrics 400, both historical and otherwise can be used to develop a set of indicators and other derived information (enumerated together as 405) to be used with the different models. The application usage pattern model 410 and application priority model 420 each use this information as a set of rules that are then provided to create the application logs flow control policy 430. Together this will then create the final rules/policy that will be used in management of log processing. As indicated by the arrows, each independent model can be used to supply additional input to other models. It should be noted that in each case, the metrics 400 can be used to derive other values (405) as discussed to be used further in rule/policy determination.

To provide a better understanding of some information that may be considered in each historical data category, some examples of each category will be presently provided with the understanding that in alternate embodiments, other components may also be examined.

For example, in the category of Logs all recorded logs are examined. This includes extracting their severity and importance in loglines.

The metrics examined may include Cluster Resources Utilization (minimum values, maximum values, averages, and variance). Other similar resource utilization will also be considered depending on the architecture of the computing environment, for example, when a network may be used, the Network Resource Utilization (minimum values, maximum values, averages and variance) will be considered.

As with regards to Events analysis, components such as Rate of Non-healthy Events, rates of upgrades, and other similar event counts such as specific patches and the like are considered and analyzed.

Information analyzed regarding Tickets includes number of tickets received and processed, average response time, number of escalations and number of users that were involved (affected) in each ticket generated.

Trace information can include latencies, request rates and dependencies such as micro-service level.

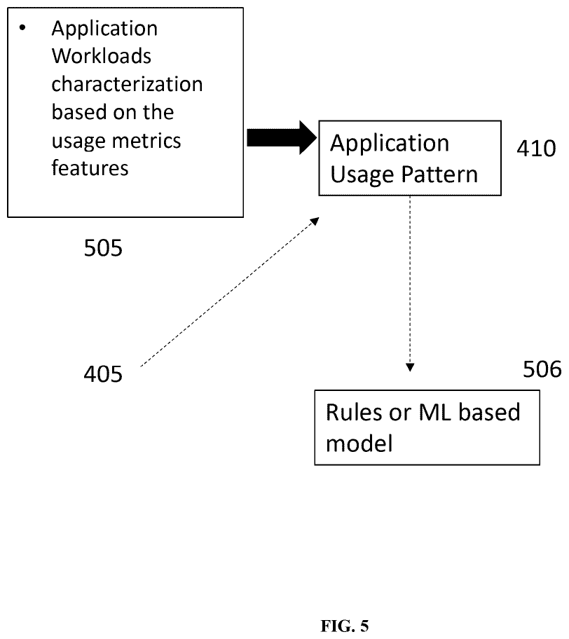

FIGS. 5-7 provide a more detailed illustration of some of the information regarding establishing Models 410-430. FIG. 5 provides the Application Usage Pattern Model 410 described previously with respect to FIG. 4, as per one embodiment. In addition to the metrics (historical/current data) 400 generally discussed in connection with FIG. 4, other values/metrics 405, other components that may also be considered here are provided in 505. These may include Application Workloads characterization based on a variety of factors such as application Requests (this can include requests based on quantity, or measures as per a particular time—per “Hour of Day”, “Day of Week”, “Week of Month”, “Month of Year” etc., any and/or number of Dependent Services, resource usage (memory, central processing or CPU usage, Network usage and the like). Any other information that may be pertinent to log processing can be added to these usage metrics as can be appreciated by those skilled in the art. These and previously discussed metrics (400) will enable the formation of the Application Usage Patent Model 410. The rules developed here can also be captured as in 506 and be used later development of the policy (430 in FIG. 4).

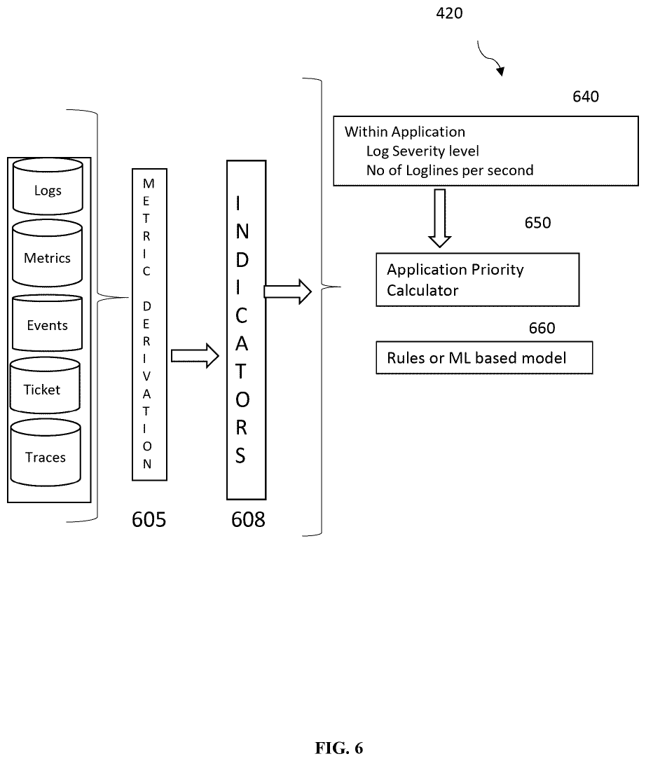

FIG. 6 provides an Application Log priority discovery leading to the development of the Application Priority Model 420. The previously defined metrics discussed (both historical and specific—such as logs, events, tickets etc.) may be used to provide a set of derived metrics 605 that will be used to provide a variety of applications and error prone factors or indicators 608 as shown. These may include such specifics as Volume of Tickets raised, Average Time taken to fix tickets, Non-Healthy Events Count, Application Metrics Raised number of Alerts, Error-Logs count. Number of escalations raised, Rate of upgrades and/or applied patches, number of dependent services, number of messages in slack incident thread and many others as can be appreciated.

These derived indicators 608 will then be used to determine application priority using a calculator (processor calculating) as shown at 650. This calculation may include certain conditions shown within each application itself 640 (as opposed to previously at 608 which reflected applications and errors overall across the multiple functions). This will ultimately produce a set of rules 660 which will be also used in policy development.

FIG. 7 provides an example of development of an Application Policy Model 430 as per one embodiment. In this scenario, information provided as a set of metrics 705 (can include such as in this example Logs and other Metrics such as previously historical ones etc.) to derive a set of indicators 708 will be ultimately used in the development to of the Application Policy Model 430. The (metric) indicators derived 708 may include a variety of metrics such as Group Log Generation Rate, Log Collector Reading Capacity, Log File Rotation Rate, Number of containers, Buffer Capacity, Resource (CPU) Availability for Log Collector, Log Collector Reading Limit and the like depending on the embodiment.

A set of rules can then be provided leading to the ultimate policy established. In this scenario, classifications are extracted and used in determining the rules. For example, the Applications are first categorized by their order of importance (priority) as shown at 740. This may be then grouped further according to Log lines and certain metrics be further calculated as shown at 750. One of the other criteria that may be determined has to do with the severity of each log (751-753). This determination, in one embodiment will be rendered, for example, by reviewing and processing all of the High priority ones 751. For Medium priority 752, for example, a limit rate may be used as a cutoff (for example may be 10%, or 20%, etc.). Low Priority 753 may also use a percentage, as previous example but rely on a higher percentage (50%, 60% etc.).

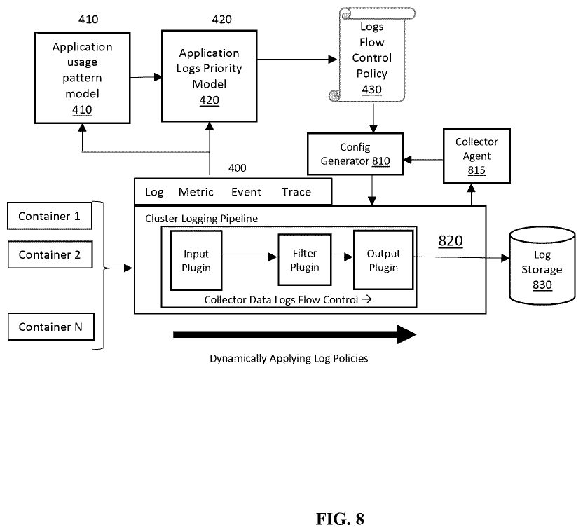

FIG. 8 provides an illustration of an overall process according to one embodiment. As shown the data 400 collected and used to derive the policies are received and manipulated by each model 410-430. This may then be used by the collector agent 810 and configuration generator 815 to manage the cluster logging pipeline 820 by dynamically applying the logging policies developed. The results and/or one or more components are stored in storage 830.

FIG. 9 provides a block diagram 900 of internal and external components of computers depicted in FIG. 1 in accordance with an illustrative embodiment of the present invention. It should be appreciated that FIG. 9 provides only an illustration of one implementation and does not imply any limitations regarding the environments in which different embodiments may be implemented. Many modifications to the depicted environments may be made based on design and implementation requirements.

Data processing system 902, 904 may be representative of any electronic device capable of executing machine-readable program instructions. Data processing system 902, 904 may be representative of a smart phone, a computer system, PDA, or other electronic devices. Examples of computing systems, environments, and/or configurations that may represented by data processing system 902, 904 include, but are not limited to, individual computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 and network server 112 may include respective sets of internal components 902 a, b and external components 904 a, b illustrated in FIG. 9. Each of the sets of internal components 902 a, b includes one or more processors 906, one or more computer-readable RAMs 908 and one or more computer-readable ROMs 910 on one or more buses 912, and one or more operating systems 914 and one or more computer-readable tangible storage devices 916. The one or more operating systems 914, the software program 108, and the log management program 110a in client computer 102, and the logging flow control application 110b in network server 112, may be stored on one or more computer-readable tangible storage devices 916 for execution by one or more processors 906 via one or more RAMs 908 (which typically include cache memory). In the embodiment illustrated in FIG. 9, each of the computer-readable tangible storage devices 916 may be a magnetic disk storage device of an internal hard drive. Alternatively, each of the computer-readable tangible storage devices 916 may be a semiconductor storage device such as ROM 910, EPROM, flash memory or any other computer-readable tangible storage device that can store a computer program and digital information.

Each set of internal components 902 a, b also includes a R/W drive or interface 918 to read from and write to one or more portable computer-readable tangible storage devices 920 such as a CD-ROM, DVD, memory stick, magnetic tape, magnetic disk, optical disk or semiconductor storage device. A software program, such as the software program 108, the log management program 110a and the logging flow control application 110b can be stored on one or more of the respective portable computer-readable tangible storage devices 920, read via the respective R/W drive or interface 918 and loaded into the respective hard drive 916.

Each set of internal components 902 a, b may also include network adapters (or switch port cards) or interfaces 922 such as a TCP/IP adapter cards, wireless wi-fi interface cards, or 3G or 4G wireless interface cards or other wired or wireless communication links. The software program 108 and the log management program 110a in client computer 102 and the logging flow control application 110b in network server computer 112 can be downloaded from an external computer (e.g., server) via a network (for example, the Internet, a local area network or other, wide area network) and respective network adapters or interfaces 922. From the network adapters (or switch port adaptors) or interfaces 922, the software program 108 and the log management 110a in client computer 102 and the logging flow control application 110b in network server computer 112 are loaded into the respective hard drive 916. The network may comprise copper wires, optical fibers, wireless transmission, routers, firewalls, switches, gateway computers and/or edge servers.

Each of the sets of external components 904 a, b can include a computer display monitor 924, a keyboard 926, and a computer mouse 928. External components 904 a, b can also include touch screens, virtual keyboards, touch pads, pointing devices, and other human interface devices. Each of the sets of internal components 902 a, b also includes device drivers 930 to interface to computer display monitor 924, keyboard 926 and computer mouse 928. The device drivers 930, R/W drive or interface 918 and network adapter or interface 922 comprise hardware and software (stored in storage device 916 and/or ROM 910).

It may be understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing may provide a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:
a. On-demand self-service: a cloud consumer can unilaterally provision computing capabilities, such as server time and network storage, as needed automatically without requiring human interaction with the service's provider.
b. Broad network access: capabilities are available over a network and accessed through standard mechanisms that promote use by heterogeneous thin or thick client platforms (e.g., mobile phones, laptops, and PDAs).
c. Resource pooling: the provider's computing resources are pooled to serve multiple consumers using a multi-tenant model, with different physical and virtual resources dynamically assigned and reassigned according to demand. There may be a sense of location independence in that the consumer generally has no control or knowledge over the exact location of the provided resources but may be able to specify location at a higher level of abstraction (e.g., country, state, or datacenter).
d. Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.
e. Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:
f. Software as a Service (SaaS): the capability provided to the consumer may be to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.
g. Platform as a Service (PaaS): the capability provided to the consumer may be to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.
h. Infrastructure as a Service (IaaS): the capability provided to the consumer may be to provision processing, storage, networks, and other fundamental computing resources where the consumer may be able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:
i. Exclusive cloud: the cloud infrastructure may be operated solely for an organization. It may be managed by the organization or a third party and may exist on-premises or off-premises.
j. Community cloud: the cloud infrastructure may be shared by several organizations and supports a specific community that has shared concerns (e.g., mission, security requirements, policy, and compliance considerations). It may be managed by the organizations or a third party and may exist on-premises or off-premises.
k. Public cloud: the cloud infrastructure may be made available to the general public or a large industry group and may be owned by an organization selling cloud services.
l. Hybrid cloud: the cloud infrastructure may provide a composition of two or more clouds (exclusive, community, or public) that remain unique entities but are bound together by standardized or proprietary technology that enables data and application portability (e.g., cloud bursting for load-balancing between clouds).

A cloud computing environment may be a service oriented with a focus on statelessness, low coupling, modularity, and semantic interoperability. At the heart of cloud computing is an infrastructure comprising a network of interconnected nodes.

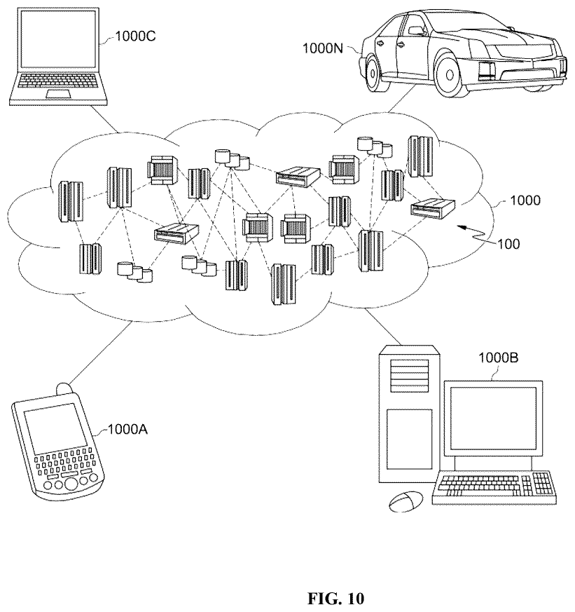

Referring now to FIG. 10, illustrative cloud computing environment 1000 may be depicted. As shown, cloud computing environment 1000 comprises one or more cloud computing nodes 100 with which local computing devices used by cloud consumers, such as, for example, digital assistants (PDA) or cellular telephone 1000A, desktop computer 1000B, laptop computer 1000C, and/or automobile computer system 1000N may communicate. Nodes 100 may communicate with one another. They may be grouped (not shown) physically or virtually, in one or more networks, such as exclusive, Community, Public, or Hybrid clouds as described hereinabove, or a combination thereof. This allows cloud computing environment 1000 to offer infrastructure, platforms and/or software as services for which a cloud consumer does not need to maintain resources on a local computing device. It can be understood that the types of computing devices 1000A-N shown in FIG. 10 are intended to be illustrative only and that computing nodes 100 and cloud computing environment 1000 can communicate with any type of computerized device over any type of network and/or network addressable connection (e.g., using a web browser).

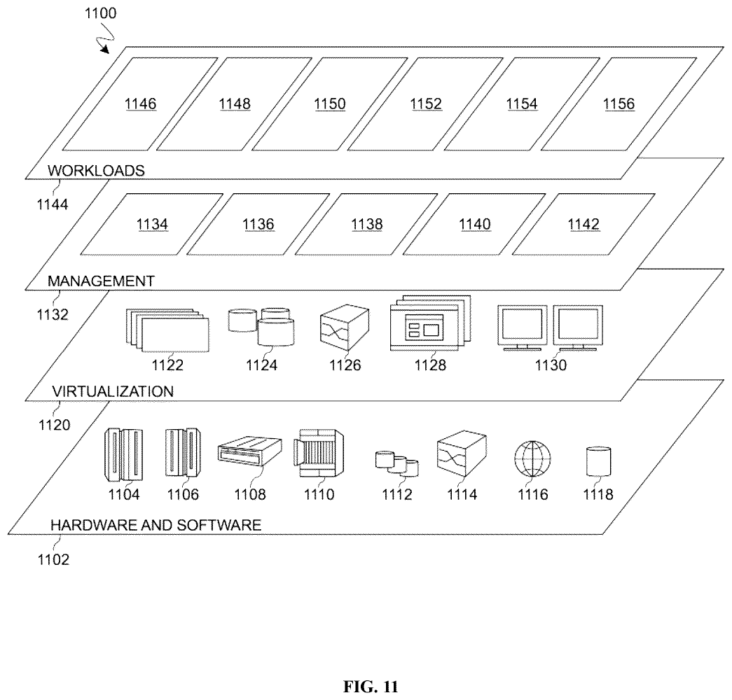

Referring now to FIG. 11, a set of functional abstraction layers 1100 provided by cloud computing environment 1000 has been shown. It should be understood in advance that the components, layers, and functions shown in FIG. 11 are intended to be illustrative only and embodiments of the invention are not limited thereto. As depicted, the following layers and corresponding functions are provided:

Hardware and software layer 1102 includes hardware and software components. Examples of hardware components include: mainframes 1104; RISC (Reduced Instruction Set Computer) architecture based servers 1106; servers 1108; blade servers 1110; storage devices 1112; and networks and networking components 1114. In some embodiments, software components include network application server software 1116 and database software 1118.

Virtualization layer 1120 provides an abstraction layer from which the following examples of virtual entities may be provided: virtual servers 1122; virtual storage 1124; virtual networks 1126, including virtual exclusive networks; virtual applications and operating systems 1128; and virtual clients 1130.

In one example, management layer 1132 may provide the functions described below. Resource provisioning 1134 provides dynamic procurement of computing resources and other resources that are utilized to perform tasks within the cloud computing environment. Metering and Pricing 1136 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 1138 provides access to the cloud computing environment for consumers and system administrators. Service level management 1140 provides cloud computing resource allocation and management such that required service levels are met. Service Level Agreement (SLA) planning and fulfillment 1142 provide pre-arrangement for, and procurement of, cloud computing resources for which a future requirement may be anticipated in accordance with an SLA.

Workloads layer 1144 provides examples of functionality for which the cloud computing environment may be utilized. Examples of workloads and functions which may be provided from this layer include: mapping and navigation 1146; software development and lifecycle management 1148; virtual classroom education delivery 1150; data analytics processing 1152; transaction processing 1154; and data management 1156.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for automatic processing of computer logging events, comprising:
determining an application priority model relating to a plurality of computer applications being executed on a device;
determining a usage patterns model by monitoring utilization of said plurality of applications based on usage of said applications by a priority of users, said application priority model and said usage pattern model providing a set of rules based on a plurality of metrics;
determining a log flow control flow policy model by using said metrics and logging information; and
managing processing a plurality of logs based on said low flow control policy and said rules provided by said application priority model and said usage pattern model.

2. The method of claim 1, wherein said plurality of metrics includes at least includes one of events, recorded logs, traces, tickets and resource utilization information.

3. The method of claim 2, wherein said metrics include current information from said currently running applications and previously recorded historical information relating to execution of applications at a previous time.

4. The method of claim 2, wherein said resource utilization information includes any cluster utilization data when said plurality of computer applications are executed on a plurality of computers that are electronically connected.

5. The method of claim 2, wherein said resource utilization information includes any network utilization data when said plurality of computer applications are executed on a plurality of computers that are electronically connected.

6. The method of claim 2, wherein information analyzed relating to events include a rate of non-healthy event counts, an events rate of upgrades and/or a plurality of patches specific or non-specific to said event counts.

7. The method of claim 1, wherein said logging flow control policy model extracts and analyzes a plurality of information about a logline importance.

8. The method of claim 7, wherein said logging flow control policy model groups a plurality of workloads by an application priority.

9. The method of claim 8, wherein said logging flow control policy model calculates a plurality of logline priority rules by analyzing a plurality of metric indicators as well as logline importance and workloads by application policy.

10. The method of claim 9, wherein said calculation also includes analyzing priority of said logs.

11. The method of claim 9, wherein said metric indicators include at least one of the following: a group log generation rate, a log collector reading capacity, a log file rotation rate, a number of containers, a buffer capacity, a processing availability for log collector, and a log collector reading limit.

12. The method of claim 2, wherein information analyzed relating to tickets includes information relating to at least one of: an average response time, a number of escalation and a number of people included in the ticket.

13. The method of claim 2, wherein information analyzed relating to traces includes information relating to at least one of: a latency, a request rate and/or a dependency at a service level.

14. The method of claim 13, wherein said service level is a microservice level.

15. The method of claim 2, wherein said log flow control policy model is updated upon receipt of new information.

16. The method of claim 15, wherein determination of operation execution processing priority for log processing is recalculated upon receiving any new information.

17. A computer system, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
determining an application priority model relating to a plurality of computer applications being executed on a device;
determining a usage patterns model by monitoring utilization of said plurality of applications based on usage of said applications by a priority of users, said application priority model and said usage pattern model providing a set of rules based on a plurality of metrics;
determining a log flow control flow policy model by using said metrics and logging information; and
managing processing a plurality of logs based on said low flow control policy and said rules provided by said application priority model and said usage pattern model.

18. The computer system of claim 17, wherein said plurality of metrics includes at least includes one of events, recorded logs, traces, tickets and resource utilization information.

19. A computer program product, comprising:
one or more non-transitory computer-readable storage media and program instructions stored on at least one of the one or more tangible storage media, the program instructions executable by a processor to cause the processor to perform a method comprising:
determining an application priority model relating to a plurality of computer applications being executed on a device;
determining an application priority model relating to a plurality of computer applications being executed on a device;
determining a usage patterns model by monitoring utilization of said plurality of applications based on usage of said applications by a priority of users, said application priority model and said usage pattern model providing a set of rules based on a plurality of metrics;
determining a log flow control flow policy model by using said metrics and logging information; and
managing processing a plurality of logs based on said low flow control policy and said rules provided by said application priority model and said usage pattern model.

20. The computer program product of claim 19, wherein said plurality of metrics includes at least includes one of events, recorded logs, traces, tickets and/or resource utilization information.
